(19) United States
(12) Patent Application Publication
(10) Pub. No.: US 2011/0304730 A1
(43) Pub. Date: Dec. 15, 2011

(54) PAN, TILT, AND ZOOM CAMERA AND METHOD FOR AIMING PTZ CAMERA

(75) Inventors: CHIEN-LIN CHEN, Tu-Cheng (TW); CHIH-CHENG YANG, Tu-Cheng (TW)

(73) Assignee: HON HAI PRECISION INDUSTRY CO., LTD., Tu-Cheng (TW)

(21) Appl. No.: 12/907,039

(22) Filed: Oct. 19, 2010

(30) Foreign Application Priority Data
Jun. 9, 2010 (TW) 99118734

(51) Int. Cl. H04N 7/18; H04N 5/262

(52) U.S. Cl. 348/143; 348/240.99; 348/E05.055; 348/E07.085

(57) ABSTRACT

A method for aiming a pan, tilt, and zoom (PTZ) camera captures a first image of a monitored area, and calculates a state vector of a predetermined object or point in the first image at one zoom setting. The state vector of the predetermined object or point is recorded in a state vector table. The method aims the PTZ camera to align a center point of the first image to a selected target point, and captures a second image of the monitored area. In order to calculate state vectors of points in the second image, N pieces of reference images related to the second image are calculated using a particle filter. After calculating a similarity between each of the N pieces of reference images and the second image, the method calculates the state vectors of the points in the second image according to each similarity, and updates the state vector table with the state vectors.

### BACKGROUND

1. Technical Field

Embodiments of the present disclosure generally relate to cameras and positioning methods, and more particularly to a pan, tilt, zoom (PTZ) camera and a method for aiming the PTZ camera.

2. Description of Related Art

PTZ cameras are commonly used in monitoring systems. When a center point of an image captured by a PTZ camera needs to be oriented onto a specific target point, then pan, tilt, and zoom settings must be pre-stored in a PTZ camera controller. If the PTZ camera has more than one target point or a route to cover, then many settings must be stored, which can use up a lot of memory of the PTZ camera controller. More memory used means more money spent.

### BRIEF DESCRIPTION OF THE DRAWINGS

FIG. 1 is a block diagram of one embodiment of a PTZ camera with an aiming unit.

FIG. 2 is a schematic diagram illustrating one example of aiming the PTZ camera.

FIG. 3 is an example illustrating tracking points in a current image and a previous image.

FIG. 4 is a flowchart illustrating one embodiment of a method of aiming the PTZ camera of FIG. 1.

FIG. 5 is a detailed description of block S14 in FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the data “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

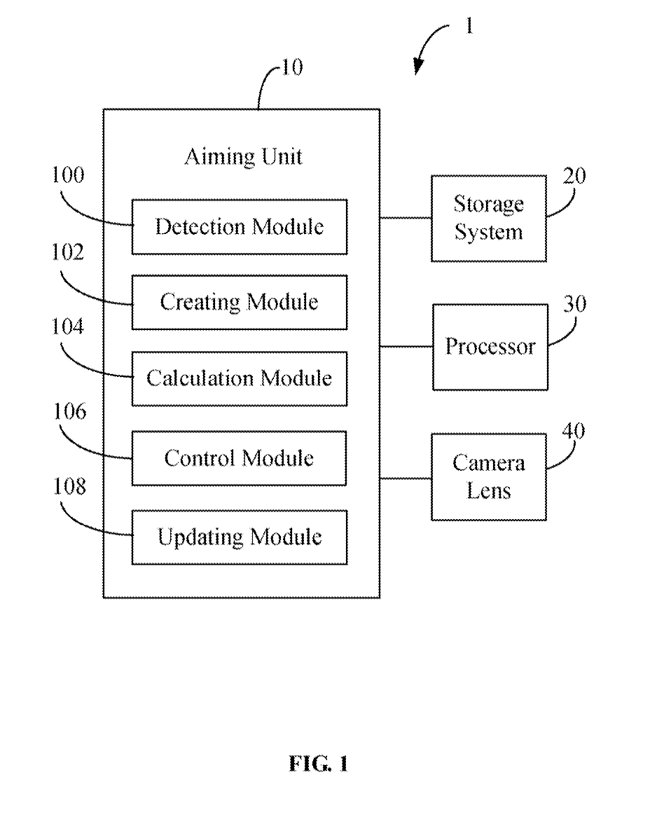

FIG. 1 is a block diagram of one embodiment of a PTZ camera 1. In the embodiment, the PTZ camera 1 includes an aiming unit 10. The aiming unit 10 is programmed to aim the PTZ camera 1 at a target point in a monitored area, according to a position of a center point of a captured image relative to the target point in the captured image.

As illustrated in FIG. 1, the PTZ camera 1 may further include a storage system 20, at least one processor 30, and a camera lens 40. In one embodiment, the aiming unit 10 includes a detection module 100, a creating module 102, a calculation module 104, a control module 106, and an updating module 108. Each of the modules 100-108 may be a software program including one or more computerized instructions that are stored in the storage system 20 and executed by the processor 30. The camera lens 40 is configured to capture images of the monitored area.

In one embodiment, the storage system 20 may be a magnetic or an optical storage system, such as a hard disk drive, an optical drive, or a tape drive. The storage system 20 stores the images captured by the camera lens 40, and stores a state vector table for recording state vectors of points in the captured images.

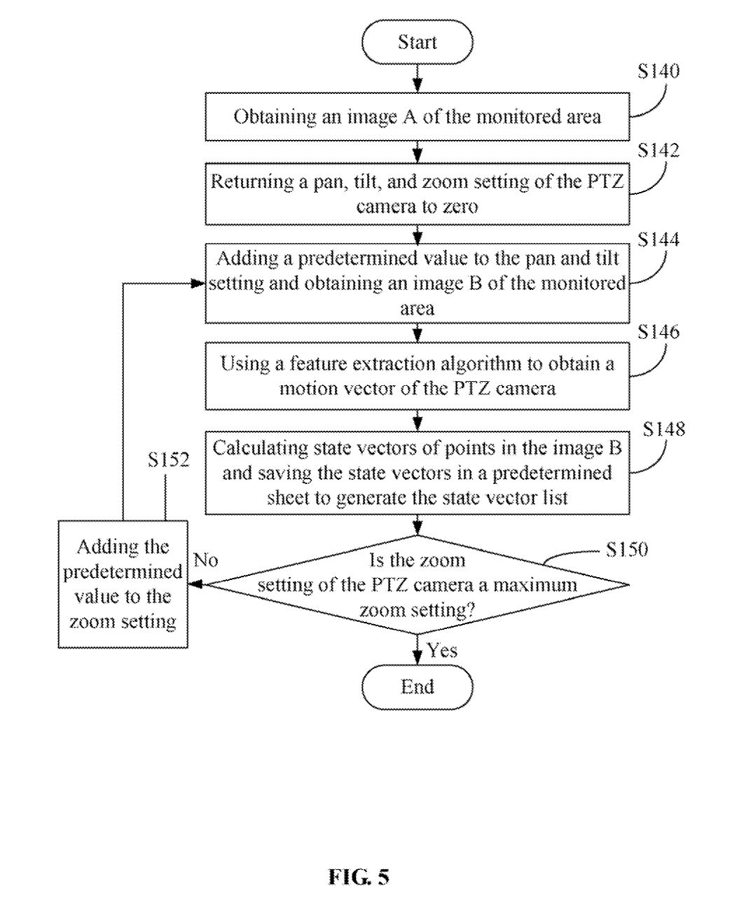

When the PTZ camera 1 is powered on, the detection module 100 detects whether the state vector table has been created in the storage system 20. If the state vector table is not found in the storage system 20, the creating module 102 creates one and stores it in the storage system 20. Details of creating a state vector table by the creating module 102 are described in FIG. 5.

In one exemplary embodiment, a state vector model of a two-dimensional camera can be defined as

$$[ \begin{matrix}{u}_{1} \\ {v}_{1}\end{matrix} ] = s [ \begin{matrix}{R}_{11} & {R}_{12} \\ {R}_{21} & {R}_{22}\end{matrix} ] [ \begin{matrix}{u}_{0} \\ {v}_{0}\end{matrix} ] + [ \begin{matrix}{t}_{x} \\ {t}_{y}\end{matrix} ] ,$$

where “s” is the zoom setting, “tₓ” and “t_{y}” are movement distances of the PTZ camera 1 along an x-axis and a y-axis of a three-dimensional coordinate system respectively, “R₁₁, R₁₂, R₂₁, and R₂₂” form a rotation matrix, and R₁₁R₂₁+R₁₂R₂₂+\sqrt{1−R₁₁²−R₁₂²}\sqrt{1−R₂₁²−R₂₂²}=0. The state vector of a predetermined object or point in an image captured at a time K can be defined as [Sₖ, tₓₖ, t_{yk}, R_{11K}, R_{12K}, R_{21K}]^{r}.

If the state vector table is found in the PTZ camera 1, the calculation module 104 records a current image captured by the camera lens 40 at one zoom setting, calculates a state vector of a predetermined object or point in the current image, and records the state vector in the state vector table.

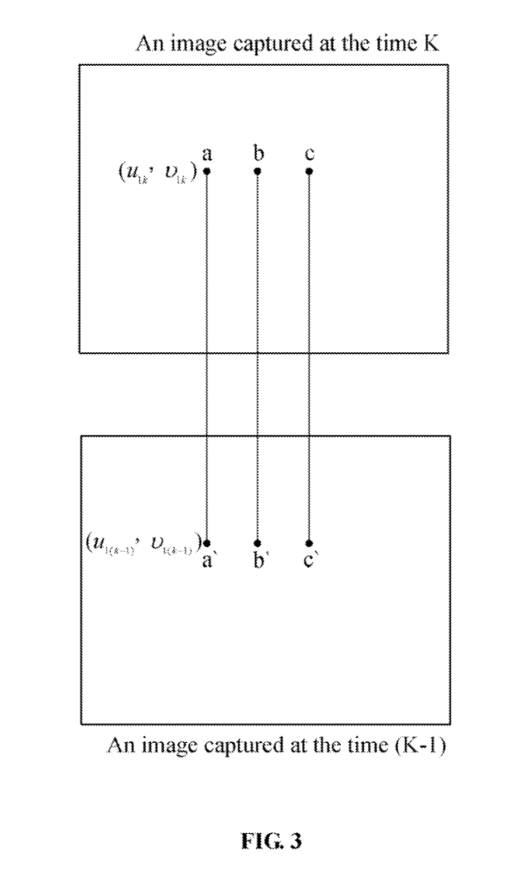

In one embodiment, if the PTZ camera 1 has not moved between the time of capture of the current image and a previous image, the calculation module 104 determines that the state vector of the predetermined object or point in the current image equals the state vector of a corresponding object or point in the previous image. For example, the state vector of the corresponding object or point in the previous image is the state vector lastly recorded in the state vector table. If the PTZ camera 1 has moved between the time of capture of the current image and the previous image, the calculation module 104 calculates the state vector of the predetermined object or point in the current image using to the state vector of the corresponding object or point in the previous image and a feature extraction algorithm. For example, as illustrated in FIG. 3, three points a, b, and c in the image captured at the time k are predetermined points, the calculation module 104 tracks the three points in the image captured at the time (k−1), such as the points a′, b′, and c′. As the state vectors of the three points a′, b′, and c′ are recorded in the state vector table, the calculation module 104 can calculate the state vectors of the three points a, b, and c in the image captured at the time k, according to the state vectors of the three points a, b′, and c′, and the feature extraction algorithm. A formula used as the feature extraction algorithm can be as follows:

$$[ \begin{matrix}{u}_{1 k} & {v}_{1 k} \\ {u}_{2 k} & {v}_{2 k} \\ {u}_{3 k} & {v}_{3 k}\end{matrix} ] = [ \begin{matrix}{u}_{1 ( k - 1 )} & {v}_{1 ( k - 1 )} & 1 \\ {u}_{2 ( k - 1 )} & {v}_{2 ( k - 1 )} & 1 \\ {u}_{3 ( k - 1 )} & {v}_{3 ( k - 1 )} & 1\end{matrix} ] [ \begin{matrix}{\overline{s}}_{k} {\overline{R}}_{11 k} & {\overline{s}}_{k} {\overline{R}}_{12 k} \\ {\overline{s}}_{k} {\overline{R}}_{21 k} & {\overline{s}}_{k} {\overline{R}}_{22 k} \\ \overline{{tx}_{k}} & \overline{{ty}_{k}}\end{matrix} ] .$$

In one embodiment,

the feature extraction algorithm is a scale-invariant feature transform algorithm (SIFT), or a speeded up robust features algorithm (SURF), for example.

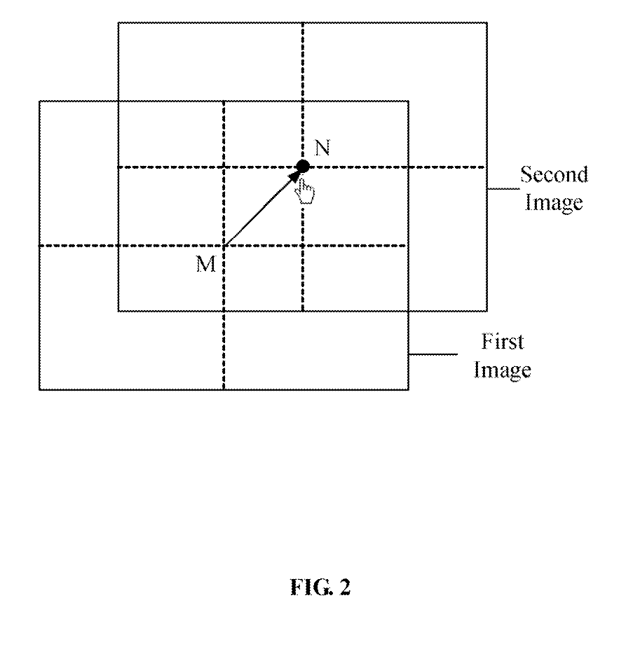

The control module 106 is used for aiming the PTZ camera 1, so as to align the center point of the current image with a selected target point in the monitored area, according to the state vector of the center point of the current image. The control module 106 obtains a new image of the monitored area captured by the camera lens 40. See in FIG. 2, the point N is a selected target point, the point M is the center point of the first image, the control module 106 aims the PTZ camera 1 to align the center point M with the selected target point N, to obtain the new image with a center point N.

The calculation module 104 further records the new image in the state vector table, uses a particle filter to calculate state vectors of points in the new image. In detail, the calculation module 104 calculates N pieces of reference images related to the new image by using a particle filter formula. In the embodiment, the particle filter formula is

$${x}_{k}^{i} \sim {q}_{G} ( \overline{{x}_{k}} , {\sum }_{1} ) = \frac{1}{\sqrt{{( 2 π )}^{6} \vert {\sum }_{1} \vert}} exp [ - \frac{1}{2} {( {x}_{k}^{i} - \overline{{x}_{k}} )}^{T} {\sum }_{1}^{- 1} ( {x}_{k}^{i} - \overline{{x}_{k}} ) ] ,$$

where a range of “i” is “1˜N,” q_{G}( x̅ₖ̅,Σ₁) is a Gaussian equation, x̅ₖ̅ is an average state vector, and Σ₁ is a mutation matrix. The calculation module 104 calculates a similarity between each of the N pieces of reference images and the new image, and calculates the state vectors of the points in the new image according to each similarity. In the embodiment, the reference image, which is similar to the new image, may be a previous image of the second image. The calculation module 104 can calculate the state vectors of the points in the new image according to the previous image.

The updating module 106 updates the state vector table with the state vectors of the points in the new image.

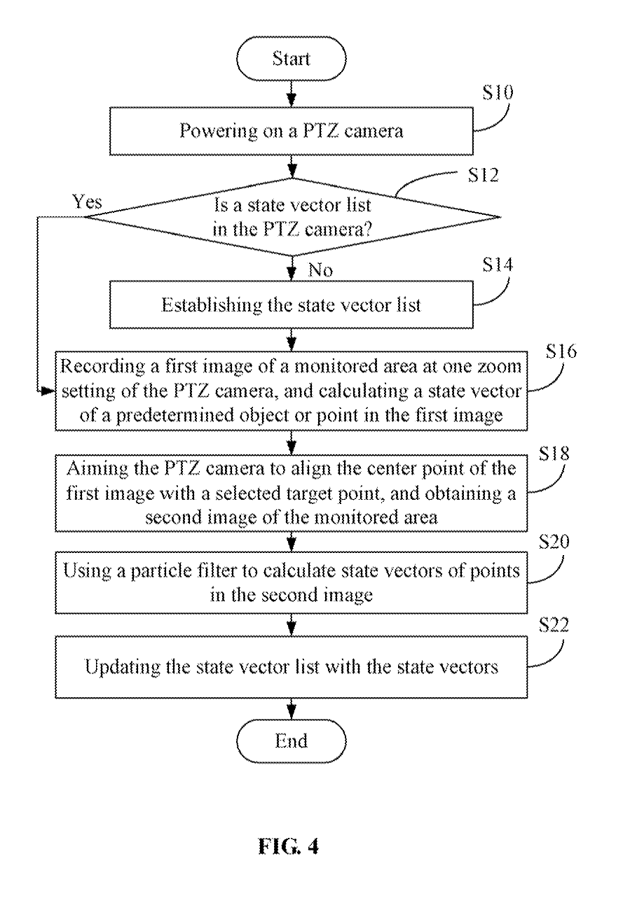

FIG. 4 is a flowchart illustrating one embodiment of a method of aiming the PTZ camera 1 of FIG. 1. Depending on the embodiment, additional blocks may be added, others removed, and the ordering of the blocks may be changed.

In block S10, the PTZ camera 1 is powered on.

In block S12, the detection module 100 detects whether the state vector table has been created in the storage system 20. In one embodiment, the state vector table is used for recording state vectors of points in the images captured by the camera lens 40. If the state vector table is not found in the storage system 20, block S14 is implemented. If the state vector table is found in the PTZ camera 1, block S16 is implemented.

In block S14, the creating module 102 creates the state vector table and stores the state vector table in the storage system 20. Details of creating a state vector table by the creating module 102 are described in FIG. 5.

In block S16, the calculation module 104 records a first image of a monitored area captured by the camera lens 40 at one zoom setting, calculates a state vector of a predetermined object or point in the first image, and records the state vector in the state vector table.

In block S18, the control module 106 aims the PTZ camera 1, to align a center point of the first image with a selected target point in the monitored area, according to the state vector of the center point of the first image. The control module 106 obtains a second image of the monitored area captured by the camera lens 40.

In block S20, the calculation module 104 calculates N pieces of reference images related to the second image using a particle filter, calculates a similarity between each of the N pieces of reference images and the second image, and calculates state vectors of points in the second image according to each similarity.

In block S22, the updating module 108 updates the state vector table with the state vectors of the points in the second image.

FIG. 5 is a detailed description of block S14 in FIG. 4.

In block S140, the creating module 102 records an image A of the monitored area that is captured by the camera lens 40.

In block S142, the creating module 102 returns pan, tilt, and zoom settings of the PTZ camera 1 to zero.

In block S144, the creating module 102 adds a predetermined value to the pan and tilt settings, and obtains an image B of the monitored area that is captured by the camera lens 40.

In block S146, the creating module 102 obtains a motion vector of the PTZ camera 1 by using a feature extraction algorithm. As described above, the feature extraction algorithm may be the SIFT, or the SURF.

In block S148, the creating module 102 calculates state vectors of points in the image B according to the motion vector of the PTZ camera 1 and the image A, and saves the state vectors in a predetermined sheet to generate the state vector table.

In block S150, the creating module 102 detects whether the zoom setting of the PTZ camera 1 is a maximum zoom setting. If the zoom setting of the PTZ camera 1 is not the maximum zoom setting, block S152 is implemented. If the zoom setting of the PTZ camera 1 is the maximum zoom setting, the flow ends.

In block S152, the creating module 102 adds the predetermined value to the zoom setting, and block S144 is repeated.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An aiming method for a pan, tilt, and zoom (PTZ) camera, the method comprising:
recording a first image of a monitored area captured by a camera lens of the PTZ camera;
calculating a state vector of a predetermined object or point in the first image at one zoom setting of the PTZ camera, and recording the state vector of the predetermined object or point in a state vector table;
aiming the PTZ camera to align a center point of the first image to a selected target point in the monitored area according to the zoom setting and the state vector of the predetermined object or point in the first image, and recording a second image of the monitored area captured by the camera lens;
using a particle filter to calculate N pieces of reference images related to the second image;
calculating a similarity between each of the N pieces of reference images and the second image, and calculating state vectors of points in the second image according to each similarity; and
updating the state vector table with the state vectors of the points in the second image.

2. The method as described in claim 1, wherein the state vector table records a plurality of zoom settings and state vectors of points in the captured images.

3. The method as described in claim 2, further comprising:
detecting whether the state vector table has been created in the PTZ camera;
upon the condition that the state vector table is not found in the PTZ camera, creating the state vector table and stores the state vector table in the PTZ camera; or
upon the condition that the state vector table is found in the PTZ camera, executing the recording to record the first image.

4. The method as described in claim 3, wherein the creating block comprises:
capturing an image A of the monitored area by the camera lens;
returning a pan, tilt, and zoom setting of the PTZ camera to zero;
adding a predetermined value to the pan and tilt setting, and capturing an image B of the monitored area;
obtaining a motion vector of the PTZ camera by using a feature extraction algorithm; and
calculating the state vectors of points in the image B according to the motion vector of the PTZ camera and the image A, and saving the state vectors of the points in a predetermined sheet to generate the state vector table.

5. The method as described in claim 4, further comprising:
detecting whether the zoom setting of the PTZ camera is a maximum zoom setting; and
adding the predetermined value to the zoom setting upon the condition that the zoom setting of the PTZ camera is not the maximum zoom setting.

6. The method as described in claim 4, wherein the block of calculating the state vector of the predetermined object or point in the first image at one zoom setting comprises:
determining whether the PTZ camera has moved between the time of capture of the first image and a previous image;
upon the condition that the PTZ camera has not moved between the time of capture of the first image and the previous image, determining that the state vector of the predetermined object or point in the first image equals the state vector of a corresponding point lastly recorded in the state vector table; or
upon the condition that the PTZ camera has moved between the time of capture of the first image and the previous image, assigning three points in the first image, tracking the three points in the previous image to obtain three pairs of points, and calculating the state vectors of the three points in the first image according to the state vectors of the three points in the previous image and the feature extraction algorithm.

7. The method as described in claim 6, wherein the feature extraction algorithm is a scale-invariant feature transform algorithm, or a speeded up robust features algorithm.

8. A pan, tilt, and zoom (PTZ) camera, comprising:
at least one processor;
a storage system;
a camera lens for capturing a first image of an monitored area to be monitored; and
an aiming unit stored in the storage system and executed by the at least one processor, the aiming unit comprising:
a calculation module operable to calculate a state vector of a predetermined object or point in the first image at one zoom setting of the PTZ camera, and record the state vector of the predetermined object or point in a state vector table;
a control module operable to aim the PTZ camera to align a center point of the first image to a selected target point according to the zoom setting and the state vector of the center point of the first image, and obtain a second image of the monitored area captured by the camera lens;
the calculation module further operable to record the second image in the state vector table, use a particle filter to calculate N pieces of reference images related to the second image, calculate a similarity between each of the N pieces of reference images and the second image, and calculate state vectors of points in the second image according to each similarity; and
an updating module operable to update the state vector table with the state vector of the predetermined object or point in the second image.

9. The PTZ camera as described in claim 8, wherein the aiming unit further comprises a detection module that is operable to detect whether the state vector table has been created in the storage system.

10. The PTZ camera as described in claim 9, wherein the aiming unit further comprises a creating module operable to creating the state vector table upon the condition that the state vector table is not found in the storage system, and the state vector table recording zoom settings and state vectors of points in captured images.

11. The PTZ camera as described in claim 10, wherein the creating module establishes the state vector table by:
capturing an image A of the monitored area by the camera lens;
returning a pan, tilt, and zoom setting of the PTZ camera to zero;
adding a predetermined value to the pan and tilt setting, and capturing an image B of the monitored area;
obtaining a motion vector of the PTZ camera by using a feature extraction algorithm; and
calculating the state vectors of points in the image B according to the motion vector of the PTZ camera and the image A, and saving the state vectors of the points in a predetermined sheet to generate the state vector table.

12. The PTZ camera as described in claim 11, wherein the feature extraction algorithm is a scale-invariant feature transform algorithm, or a speeded up robust features algorithm.

13. A non-transitory storage medium having stored thereon instructions that, when executed by a processor of a pan, tilt, and zoom (PTZ) camera, cause the PTZ camera to perform a method for aiming the PTZ camera, the method comprising:
recording a first image of a monitored area captured by a camera lens of the PTZ camera;
calculating a state vector of a predetermined object or point in the first image at one zoom setting of the PTZ camera, and recording the state vector of the predetermined object or point in a state vector table;
aiming the PTZ camera to align a center point of the first image to a selected target point in the monitored area according to the zoom setting and the state vector of the predetermined object or point in the first image, and recording a second image of the monitored area captured by the camera lens;
using a particle filter to calculate N pieces of reference images related to the second image;
calculating a similarity between each of the N pieces of reference images and the second image, and calculating state vectors of points in the second image according to each similarity; and
updating the state vector table with the state vectors of the points in the second image.

14. The storage medium as described in claim 13, wherein the state vector table is used for recording zoom settings and state vectors of points in captured images.

15. The storage medium as described in claim 14, wherein the method further comprises:
detecting whether the state vector table has been created in the PTZ camera;
upon the condition that the state vector table is not found in the PTZ camera, creating the state vector table and stores the state vector table in the PTZ camera; or
upon the condition that the state vector table is found in the PTZ camera, executing the recording to record the first image.

16. The storage medium as described in claim 15, wherein the creating block comprises:
capturing an image A of the monitored area by the camera lens;
returning a pan, tilt, and zoom setting of the PTZ camera to zero;
adding a predetermined value to the pan and tilt setting, and capturing an image B of the monitored area;
obtaining a motion vector of the PTZ camera by using a feature extraction algorithm; and
calculating the state vectors of points in the image B according to the motion vector of the PTZ camera and the image A, and saving the state vectors of the points in a predetermined sheet to generate the state vector table.

17. The storage medium as described in claim 16, wherein the aim method further comprises:
detecting whether the zoom setting of the PTZ camera is a maximum zoom setting; and
adding the predetermined value to the zoom setting upon the condition that the zoom setting of the PTZ camera is not the maximum zoom setting.

18. The storage medium as described in claim 16, wherein the block of calculating the state vector of the predetermined object or point in the first image at one zoom setting comprises:
determining whether the PTZ camera has moved between the time of capture of the first image and a previous image;
upon the condition that the PTZ camera does not have moved between the time of capture of the first image and the previous image, determining that the state vector of the predetermined object or point in the first image equals the state vector of a corresponding point lastly recorded in the state vector table; or
upon the condition that the PTZ camera has moved between the time of capture of the first image and the previous image, assigning three points in the first image, tracking the three points in the previous image to obtain three pairs of points, and calculating the state vectors of the three points in the first image according to the state vectors of the three points in the previous image and the feature extraction algorithm.

19. The storage medium as described in claim 17, wherein the feature extraction algorithm is a scale-invariant feature transform algorithm, or a speeded up robust features algorithm.
